(19) United States
(12) Patent Application Publication
(10) Pub. No.: US 2016/0018052 A1
(43) Pub. Date: Jan. 21, 2016

(54) Bracket Having Pivoting Support Arm

(71) Applicant: Philip Herman, New Columbia, PA (US)

(72) Inventor: Philip Herman, New Columbia, PA (US)

(21) Appl. No.: 14/710,969

(22) Filed: May 13, 2015

Related U.S. Application Data
(60) Provisional application No. 61/992,274, filed on May 13, 2014.

(51) Int. Cl. F16M 13/02; F16B 2/10; F16B 2/00

(52) U.S. Cl. CPC F16M 13/02; F16B 2/005; F16B 2/10

(57) ABSTRACT

A mountable bracket for supporting an object. The mountable bracket can be secured to various surfaces including a wall or the underside of a piece of furniture in order to provide secure and discrete storage of various objects, such as firearms. The mountable bracket includes a base plate having a planar construction that can be positioned flush against a support surface. A lower end of the mountable bracket includes a support arm pivotally connected thereto via a spring-biased hinge. In a resting configuration, a first section of the support arm extends outward from the base plate at an upward angle, and further includes a second section that is parallel to the base plate. The support arm can be pivoted between the resting configuration and an open configuration, wherein the tension provided by the spring-biased hinge secures an object between the base plate and support arm.

### CROSS REFERENCE TO RELATED APPLICATION

This application claims the benefit of U.S. Provisional Application No. 61/992,274 filed on May 13, 2014. The above identified patent application is herein incorporated by reference in its entirety to provide continuity of disclosure.

### BACKGROUND OF THE INVENTION

1. Field of the Invention

The present invention relates to a mountable bracket for holding an object. More specifically, the present invention provides a mountable bracket having a base plate and a support arm pivotally connected to a lower end thereof by means of a spring biased hinge, wherein an object can be secured between the base plate and the support arm by means of the tension provided by the spring-biased hinge.

It can be difficult to store a firearm in a location that is easily accessible and that is also secure. Many people hide firearms underneath or on top of various pieces of furniture. However, the firearm is unsecured and can be easily or accidentally removed from the storage location. This can cause the firearm owner to have difficulty locating or accessing the firearm in a time of need. Further, if the firearm falls from an elevated location or is stored adjacent to other objects, there is a risk that the firearm can accidentally fire.

Some devices in the prior art have been disclosed that relate to wall mounted gun holding devices, such as U.S. Published Patent Application Number 2005/0242251, U.S. Published Patent Application Number 2011/0198474, and U.S. Pat. No. 4,434,703. Other devices relate to gun holders having locking mechanisms, such as U.S. Pat. No. 5,271,174 and U.S. Pat. No. 6,330,815.

These prior art devices have several known drawbacks. Such devices fail to provide a mountable bracket having a base plate and a pivoting support arm thereon, wherein the support arm is spring-biased so as to support a firearm between the support arm and base plate. The mountable bracket is adapted to support various types of firearms and can be used alone or in combination with additional mountable brackets in order to support a firearm in a desired location, such as on a wall or on the side or underside of a piece of furniture.

In light of the devices disclosed in the prior art, it is submitted that the present invention substantially diverges in design elements from the prior art and consequently it is clear that there is a need in the art for an improvement to existing mountable bracket devices for supporting objects. In this regard the instant invention substantially fulfills these needs.

### SUMMARY OF THE INVENTION

In view of the foregoing disadvantages inherent in the known types of mountable brackets now present in the prior art, the present invention provides a new mountable bracket wherein the same can be utilized for providing convenience for the user when mounting a firearm in a secure and easily accessible manner.

It is therefore an object of the present invention to provide a new and improved mountable bracket device that has all of the advantages of the prior art and none of the disadvantages.

It is another object of the present invention to provide a mountable bracket having a base plate and a support arm pivotally connected thereto via a spring-biased hinge.

Another object of the present invention is to provide a mountable bracket having a planar base plate that can be mounted to any of various support surfaces via conventional fasteners.

Yet another object of the present invention is to provide a mountable bracket having a support arm that can be pivoted between a resting configuration, in which the support arm secures an object, and an open configuration wherein the object can be removed from the bracket.

A further object of the present invention is to provide a mountable bracket having an angled support arm comprising a first section that extends from the base plate at an upward angle and a second section that is parallel to the base plate.

Another object of the present invention is to provide a mountable bracket that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the mountable bracket of the present invention.

FIG. 2 shows a side view of the mountable bracket in an open and resting configuration.

FIG. 3 shows a perspective view of the bracket as used to support a firearm thereon.

### DETAILED DESCRIPTION OF THE INVENTION

Reference is made herein to the attached drawings. Like reference numerals are used throughout the drawings to depict like or similar elements of the bracket device of the present invention. For the purposes of presenting a brief and clear description of the present invention, the preferred embodiment will be discussed as used for supporting a firearm or other object in a secure and easily accessible manner. The figures are intended for representative purposes only and should not be considered to be limiting in any respect.

Referring now to FIG. 1, there is shown a perspective view of the mountable bracket of the present invention. The mountable bracket 11 comprises a base plate 12 having an upper end 18 and a lower end 19. The base plate 12 preferably comprises a planar construction so that it can be positioned flush against a support surface, such as a wall. The base plate 12 includes one or more apertures 17 therethrough, through which a fastener, such as a screw, bolt, or nail, among others, can be inserted so as to secure the base plate 12 to a support surface. In the illustrated embodiment of the present invention, the base plate 12 comprises a substantially rectangular configuration, however, in alternate embodiments, the base plate 12 may comprise alternate configurations.

A support arm 14 is pivotally connected to the lower end 19 of the base plate 12 by a hinge 13. The hinge 13 is preferably a spring-biased hinge. In the illustrated embodiment, the support arm 14 comprises a first section 15 that extends outward from the base plate 12 at an upward angle and that includes a second section 16 that is parallel to the base plate 12 when the support arm 14 is in a resting configuration. The hinge 13 is biased such that the support arm 14 is adjacent to the base plate 12 in a resting configuration, wherein the support arm 14 is separated from the base plate 12 so as to provide space for an object between the base plate 12 and support arm 14. In an open configuration, the support arm 14 is pivoted away from the base plate 12 so as to allow a user to insert an object therebetween.

In the illustrated embodiment, the support arm 14 comprises a U-shape configuration, such that the support arm 14 includes a first arm and a second arm separated by a space. However, in alternate configurations, the support arm 14 may include a single arm, or may include additional arms. Further, the upper end 22 of the second section 16 of the support arm 14 may be angled outward and away from the base plate 12 so as to facilitate insertion of an object into the space between the support arm 14 and base plate 12.

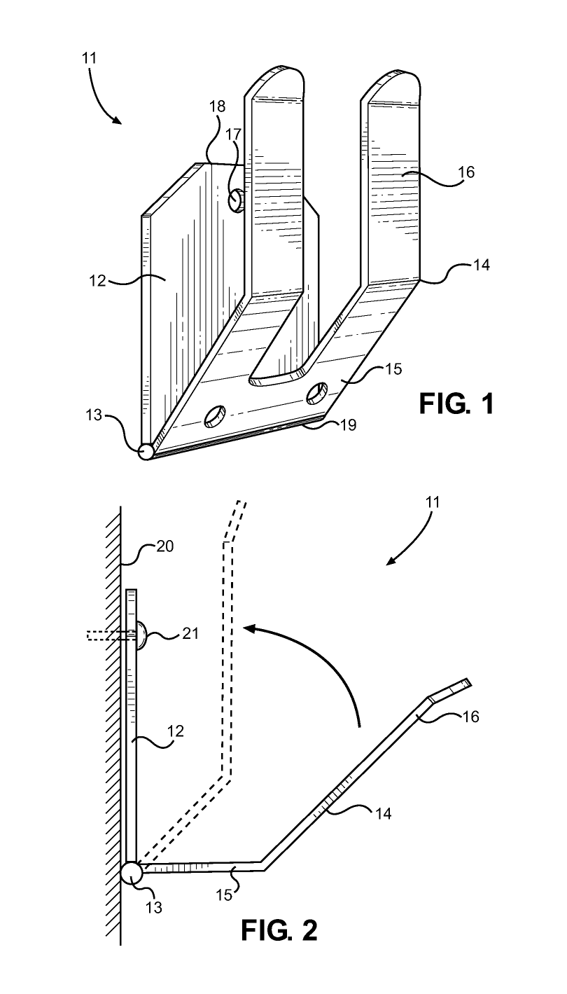

Referring now to FIG. 2, there is shown a side view of the mountable bracket in an open and resting configuration. In operation, the base plate 12 can be mounted flush against a support surface 20 and secured thereto by inserting one or more fasteners 21 through the apertures on the base plate 12 and into the support surface 20.

The support arm 14 can be rotated away from the base plate 12 via the hinge 13 so as to facilitate insertion of an object between the base plate 12 and support arm 14. In the open configuration, the support arm 14 is under tension, as the support arm 14 prefers to be adjacent to the base plate 12. In the open configuration, the first section 15 of the support arm 14 can be perpendicular to the base plate 12 so as to create sufficient space for insertion of an object, such as a firearm. In order to ensure that the object does not slip or slide off of the bracket 11, the surface of the base plate 12 may include a non-slip coating thereon, and similarly the inner surface of the support arm 14 may include a non-slip coating. In the closed configuration, the second section 16 of the support arm 14 is roughly parallel to the base plate 12 and is separated therefrom by a space.

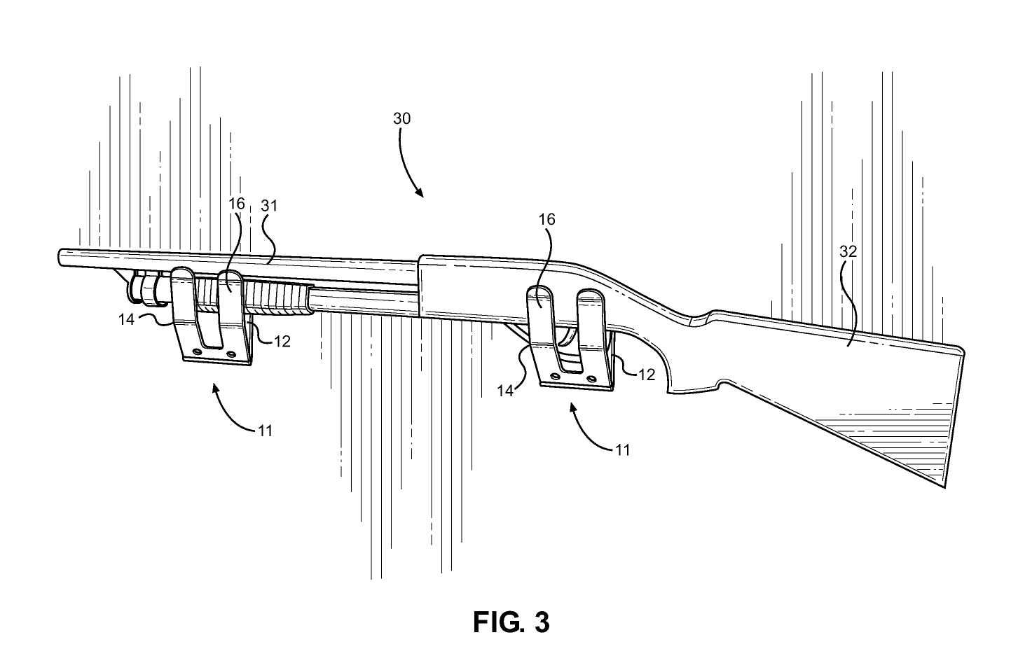

Referring now to FIG. 3, there is shown a perspective view of the bracket as used to support a firearm thereon. One or more mountable brackets 11 of the present invention can be used to support an elongated object, such as a rifle or shotgun. The brackets 11 are preferably used to support the barrel of the firearm, wherein one bracket is positioned adjacent to the front of the firearm and the second bracket is adjacent to the rear of the firearm.

In order to secure the firearm on the mountable brackets 11, the support arms 14 of the mountable brackets 11 can be pivoted into an open configuration. The user can then insert a portion of the barrel 31 of the firearm 30 in the space between the base plate 12 and the support arm 14. The handle 32 of the firearm 30 can extend away from the brackets 11. Once the firearm 30 is positioned within the brackets 11, the support arms 14 can be allowed to return to a resting configuration. The support arms 14 are under tension as result of the spring-biased hinge and will press against the object in order to suspend the object on the bracket 11.

In operation, a user can use one or more mountable brackets 11 in order to support various objects of different sizes. Further, the user can secure the mountable brackets to various support surfaces such as walls, doors, the underside of articles of furniture, and various other locations. In this way, the user can suspend and secure objects, such as firearms in various locations so that the objects are easily accessible and so that the objects are securely stored.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A bracket for holding an object, comprising:
a base plate adapted to be secured to a support surface;
a support arm pivotally secured to a lower end of said base plate by means of a spring-biased hinge, wherein said support arm is adapted to be selectively moved between an open configuration and a resting configuration.

2. The bracket for holding an object of claim 1, wherein said base plate comprises a planar configuration such that said base plate can be positioned flush against the support surface.

3. The bracket for holding an object of claim 1, wherein said base plate comprises one or more apertures therethrough adapted to receive a fastener.

4. The bracket for holding an object of claim 1, wherein said support arm comprises a first section that extends from said base plate at an upward angle, and a second section that is substantially parallel to said base plate when said support arm is in a resting configuration.

5. The bracket for holding an object of claim 1, wherein said support arm comprises a U-shaped configuration.

6. The bracket for holding an object of claim 1, wherein said support arm is adjacent to said base plate when said support arm is in a resting configuration.

7. The bracket for holding an object of claim 1, wherein said support arm includes a non-slip coating thereon.

8. The bracket for holding an object of claim 1, wherein said support arm includes a first arm and a second arm.
